(19) United States
(12) Patent Application Publication
(10) Pub. No.: US 2004/0268095 A1
(43) Pub. Date: Dec. 30, 2004

(54) Efficient implementation of null reference check

(76) Inventors: Tatiana Shpeisman, Menlo Park, CA (US); Ali-Reza Adl-Tabatabai, Santa Clara, CA (US); Jayashankar Bharadwaj, Saratoga, CA (US)

Correspondence Address: Chui-Kiu Teresa Wong, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/611,283

(22) Filed: Jun. 30, 2003

(51) Int. Cl. G06F 9/00

(52) U.S. Cl. 712/225; 712/235

(57) ABSTRACT

A method to efficiently implement a null reference check has been disclosed. The method comprises executing a speculative load instruction to load data from an address, checking whether the speculative load instruction execution fails, and raising a null reference exception if the speculative load instruction fails. In one embodiment, the method includes executing a speculative load instruction to load data from an address that includes a base address, checking whether the speculative load instruction execution fails, and checking whether the base address is null if the speculative load instruction execution fails.

### FIELD OF INVENTION

Embodiments of the present invention relate to processing load instructions in a computing system, and more particularly, to performing a null reference check on load instruction execution.

### BACKGROUND

When executing programs generated from type safe languages, such as Java, or C#, all heap accesses must be checked at run time. A heap is a portion of memory space where objects are allocated dynamically. A load of data from an object allocated in a heap raises a null reference exception if the base reference of the object is null. A load of data from an array causes array index out of bounds exception if array index is out of bounds. The null reference exception has to be checked first, and thus, the null reference exception imposes the most constraints on optimizations and instruction scheduling. Moreover, type safe languages such as Java, or C# require the exceptions to be precise, i.e., the side effects of all source byte codes before the point the exception is raised must have taken place and the side effects of any byte codes after the point where the exception is raised must not have taken place. The compiler has to guard all heap accesses with exception checks and to dispatch the exceptions raised to the handler specified in the program. The precise exceptions require the compiler to preserve ordering between the instructions that may raise exceptions and instructions that affect program state visible to the user, e.g., stores to memory.

An existing mechanism to implement a null reference check uses an explicit compare-and-branch technique. Before each heap access from an object, an explicit compare-and-branch sequence compares the base reference of the object against a null and branches to the exception throwing code if the reference is null. The method executes two instructions in every null reference check and a null reference check is performed for every heap access. Experiments showed that enabling the null reference checks implemented with the compare-and-branch instructions added up to 5% overhead to program execution time compared to disabling null reference checks.

Computer operating systems typically reserve the first virtual page in a memory as a guard page, which has a base address equal to null. A memory access to the first virtual page results in a memory protection fault. Therefore, when the base address of an object is a null, an access to the data in the object causes a memory protection fault if the field offset is smaller than the size of the virtual page. When the memory protection fault occurs, the processor raises a hardware fault which operating system translates into a signal.

Another existing mechanism to implement a null reference check is using the operating system page protection mechanism, which performs the check implicitly by trapping accesses to the zero'th page. Upon an attempted access to the zero'th page, the operating system sends a signal, which is translated into a null reference exception. The operating system page protection mechanism limits the compiler's ability to reorder and hoist load instructions because of the precise exception requirements. As a result, the operating system page protection mechanism makes it more difficult to optimize instruction scheduling. Furthermore, it is more expensive to raise an exception through the operating system if the null reference check fails.

In a computing system supporting speculative execution, a speculative load instruction and a speculation check instruction are available to allow a compiler to reduce latency in execution by loading data in advance. The compiler converts a load instruction into a speculative load instruction and a speculation check instruction. The compiler then schedules the speculative load instruction early (at a point in the program where the normal load could not have safely been scheduled), and inserts the speculation check instruction at a later point in the program flow (where it is safe to schedule the normal load). Unlike the null reference exception, a failure in speculative load does not cause the processor to generate a fault. Instead, the processor invalidates the result of the load and sets a Not-a-Thing (“NaT”) bit associated with the target register of the load instruction. Later in the program flow, the speculation check instruction checks the NaT bit. If the NaT bit is set, the processor branches to the recovery code, which possibly re-executes the load and performs other actions necessary to recover from the speculation load failure.

### BRIEF DESCRIPTION OF THE DRAWINGS

Embodiments of the present invention will be understood more fully from the detailed description that follows and from the accompanying drawings, which however, should not be taken to limit the appended claims to the specific embodiments shown, but are for explanation and understanding only.

FIG. 1 shows an embodiment of implementing a null reference check with speculation.

FIG. 2 shows an embodiment of implementing a null reference check through control speculation.

FIG. 3A shows an alternate embodiment of implementing a null reference check with speculation.

FIG. 3B shows an embodiment of implementing a null reference check using NaT propagation.

FIG. 4 shows a sample set of instruction paths of an exemplary embodiment of a computer program.

FIG. 5 shows an embodiment to implement a null reference check by taking into consideration domination by other instructions.

FIG. 6 shows an exemplary embodiment of a computer system.

### DETAILED DESCRIPTION

In the following description, numerous specific details are set forth. However, it is understood that embodiments of the invention may be practiced without these specific details. In other instances, well-known components, structures, and techniques have not been shown in detail in order not to obscure the understanding of this description.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. The apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the embodiments as described herein.

A machine-readable medium includes any mechanism for storing or transmitting information in a form readable by a machine (e.g., a computer). For example, a machine-readable medium includes ROMs, RAMs, magnetic disk storage media, optical storage media, flash memory devices, electrical, optical, acoustical or other form of propagated signals (e.g., carrier waves, infrared signals, digital signals, etc.), etc.

One of ordinary skill in the art would appreciate that the technique disclosed below is applicable to implement the null reference checks in various environments. For example, one embodiment of the null reference check is implemented in the Java Virtual Machine environment. Another embodiment of the null reference check is implemented in the NET Common Language Runtime environment. Moreover, the technique disclosed works with any processor adopting any computer architecture that supports speculation, such as the architecture of the Itanium® processor family.

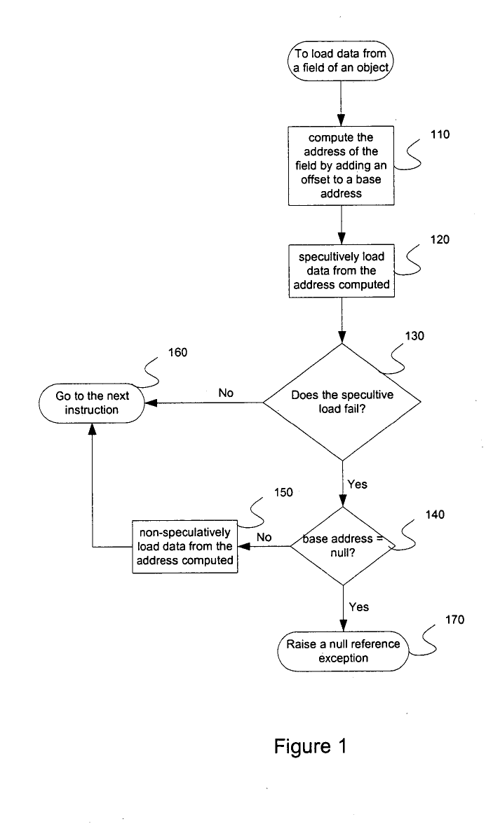

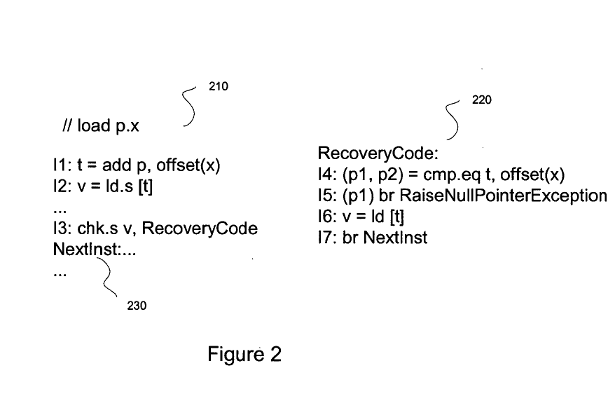

FIG. 1 shows an embodiment of implementing a null reference check with speculation. The process, like others described below, is performed by processing logic that may comprise hardware (e.g., circuitry, dedicated logic, etc.), software (such as is run on a general purpose computer system or a dedicated machine), or a combination of both. To prepare for loading data from a field of an object, processing logic computes the address of the field by adding an offset of the field to a base address of the object (processing block 110). Processing logic then speculatively loads data from the address computed (processing block 120). Processing logic checks whether the speculative load fails (processing block 130). If the speculative load does not fail, processing logic goes onto the next instruction (processing block 160). If the base address is null, the speculative load references the guard page, and therefore, fails. In an alternate embodiment, the compiler implements null as a non-zero value and guards a virtual page that corresponds to the non-zero value. —If the speculative load fails, processing logic checks whether the base address of the object is null (processing block 140). If the base address is null, then processing logic raises a null reference exception (processing block 170). Otherwise, the speculative load must have failed due to problems other than the null reference exception. For example, the processor in one embodiment is configured to fail a speculative load on the null reference or a Data Translation Lookaside Buffer (“DTLB”) miss. A DTLB is a cache storing virtual addresses of data and their corresponding physical addresses in the memory. When the address that the speculative load tries to access is not available in the DTLB, a DTLB miss occurs and causes the speculative load to fail. Processing logic loads data non-speculatively from the address computed to overcome the problems (processing block 150). Then processing logic goes onto the next instruction (processing block 160). FIG. 2 illustrates an embodiment of implementing a null reference check through control speculation. The embodiment in FIG. 2 includes seven instructions, I1-I7. In one embodiment, the instructions I1-I7 are executable by a processor in a computer system adopting the architecture of the Itanium® processor family. However, one should appreciate that other embodiments are not limited to any particular computer architecture, or any particular processor.

Referring to FIG. 2, the section of the main program 210 loads data from an object field p.x, where p is a base reference of the object and x is a field within the object. Instruction I1 computes the address of the field x by adding the offset of x to the base reference of the object, p. A load from the field p.x is implemented as a speculative load, 12, followed some time later by a speculation check, I3. When the base reference of the object is null, the speculative load fails, causing the NaT bit of the target register to be set. As a result, the check instruction, I3 transfers control to the recovery code 220.

Upon receiving control, the recovery code 220 executes instruction 14 to compare the address of the load with the field offset to verify that the failure was due to a null reference. The verification is necessary to determine whether a null reference occurs when the processor is configured to fail a speculative load for reasons in addition to a memory protection violation.

Referring to FIG. 2, if the speculative load fails due to a null reference, then instruction I5 branches to the code labeled by “RaiseNullPointerException” to raise a null reference exception. If the speculative load fails for reasons other than a null reference, then instruction I6 executes the load non-speculatively to overcome the problem causing the speculative load to fail. Then instruction 17 returns control to the main program 210 by branching back to the main instruction sequence at the label NextInst 230.

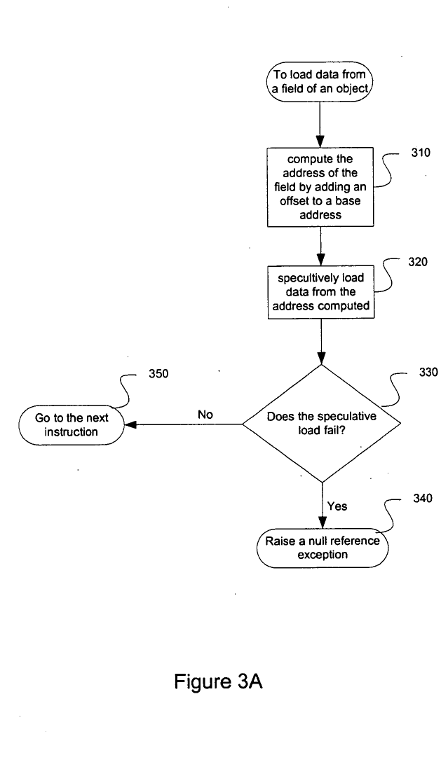

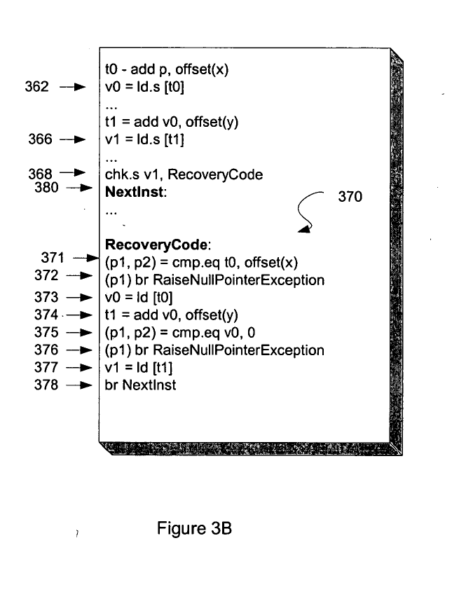

In an alternate embodiment, the processor is configured such that a speculative load does not fail on reasons other than a memory protection violation, and therefore, when a compiler knows that a null reference is the only reason for memory protection violation, the recovery code does not have to verify that the failure was due to a null reference. The recovery code simply raises a null reference exception when the speculative load fails. FIG. 3A shows a flow diagram illustrating this embodiment. The process is performed by processing logic that may comprise hardware (e.g., circuitry, dedicated logic, etc.), software (such as is run on a general purpose computer system or a dedicated machine), or a combination of both. To load data from a field of an object, processing logic computes the address of the field by adding the offset of the field to the base address of the object (processing block 310). Then processing logic speculatively loads the data from the address computed (processing block 320). Following the speculative load, processing logic checks whether the speculative load fails (processing block 330). If the speculative load fails, processing logic raises a null reference exception (processing block 340). Otherwise, processing logic goes onto the next instruction in the program (processing block 350).

In one embodiment, the computer architecture supports propagation of NaT bits. When an instruction uses an input value with a NaT bit set, the NaT bit of the result of the instruction is also set in one embodiment. This is also referred as NaT propagation. In one embodiment where NaT propagation is supported, a single speculation check is used to check if any one of multiple NaT bits associated with each other through a data dependence chain is set. In one embodiment, the null pointer exception checking for the multiple loads is moved to the recovery code. This technique is illustrated by the following example.

FIG. 3B shows an embodiment of implementing a null reference check using NaT propagation. Referring to FIG. 3B, v0 is the result of a speculative load 362 used to compute the address t1 used by the second speculative load 366. The second speculative load 366 loads data into v1. If the speculative load 362 fails, the associated NaT bit is set in one embodiment and the bit propagates to t1, and then to v1. In one embodiment, the NaT bit in v1 can also be set by a failure of the second speculative load 366. The speculation check 368, chk.s v1, transfers control to the recovery code 370 if the NaT bit is set, i.e., if either of the speculative loads 362 or 366 has failed. In the recovery code 370, the address of the speculative load 362 is compared with offset(x) at 371. If the address of the speculative load 362 is the same as the offset(x), then the speculative load 362 has failed for referencing the null and instruction 372 branches to RaiseNullPointerException to raise a null pointer exception. Otherwise, the non-speculative load 373 corresponding to the speculative load 362 is executed along with address computation into t1 by the instruction 374 in one embodiment. The base address for the second speculative load 366, namely v0, is compared with null at 375 in one embodiment. If v0 equals null, instruction 376 branches to RaiseNullPointerException to raise a null pointer exception for the second speculative load 366 in one embodiment. Otherwise, the corresponding non-speculative load 377 is executed in one embodiment. Instruction 378 then returns control to the main instruction sequence at NextInst 380.

In an alternate embodiment, a speculation check instruction, chk.s v0, is inserted into the recovery code 370 to determine whether the first speculative load 362 failed. If the first speculative load 362 did not fail, the null pointer exception checking 371-372, re-execution of the first load 373, and re-computation of the address for the second load 374 are skipped in one embodiment.

In one embodiment, the speculative load and speculation check instructions can be further optimized where there are multiple accesses to the same object, such as loading data from different fields of the same object. The processor non-speculatively loads the data if a speculative load to the same object has been checked already. In one embodiment, the compiler does not convert a load instruction into a pair of speculative load and speculation check instructions if the load instruction is dominated by a check instruction that checks the results of a speculative load to the same object, or is reached on all paths by such instructions.

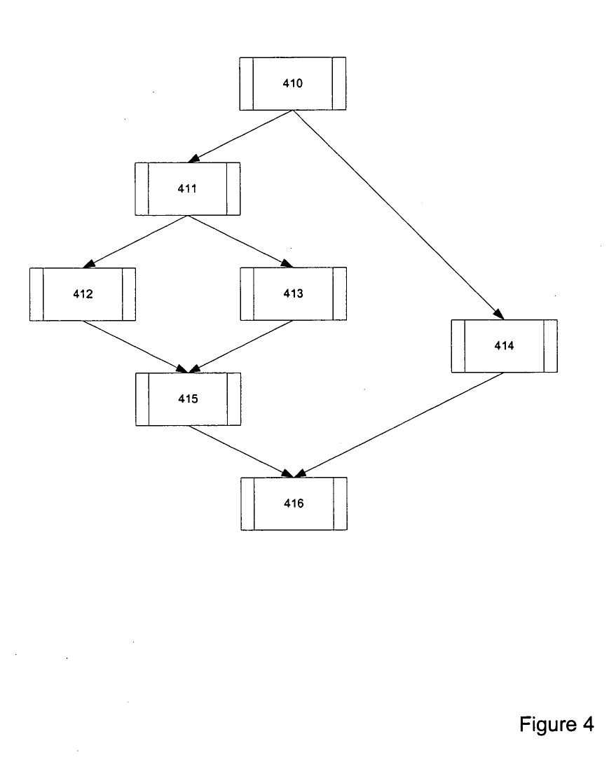

To illustrate the meaning of “being dominated,” consider the sample set of instruction paths in an exemplary embodiment of a computer program in FIG. 4. In FIG. 4, each of the blocks 410-416 represents a segment of consecutive instructions executable by a processor. There is no conditional branching within each of the blocks 410-416. The arrows going from one block to another block represent the possible paths in the program. The last instruction in block 410 may go to either block 411 or block 414. The last instruction in block 414 can go to block 416 only. The last instruction in block 411 may go to either block 412 or block 413. The last instructions in both blocks 412 and 413 can go to block 415 only. The last instruction in block 415 goes to block 416 only.

One should notice that in order to go to block 415, the processor must have gone through block 411. (That is, instructions in block 415 are dominated by instructions in block 411.) Suppose block 415 includes a load instruction from an object and block 411 includes a speculation check instruction on a speculative load from the same object. It is unnecessary to run a null reference check with respect to the object in block 415 again because the speculation check instruction in block 411 has checked the object already. On the contrary, instructions in block 416 are not dominated by the speculation check instruction in block 411 because the processor can go through the path from block 410, via block 414, to block 416 without going through block 411. In other words, it is not necessary for the processor to go through block 411 in order to get to block 416.

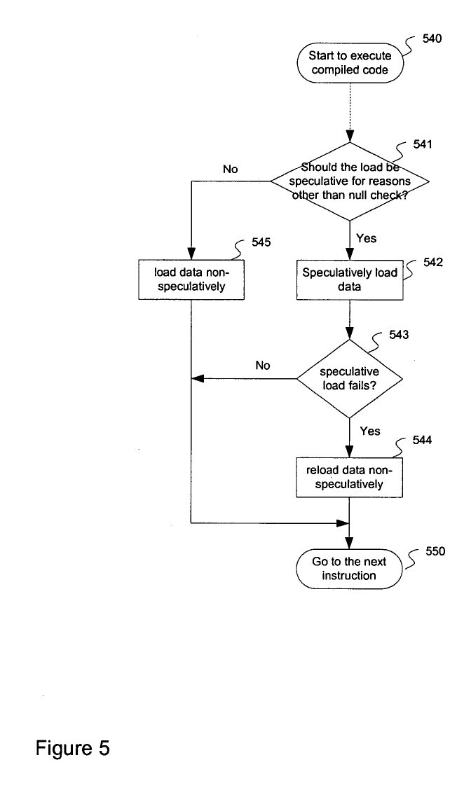

In an alternate embodiment, a compiler determines the domination relationship between the instructions in a program while compiling the program. The compiler generates code according to the domination relationship determined. There is no check on every path leading to a load instruction when the load instruction is not dominated by another instruction. Therefore, the compiler generates code as illustrated in FIG. 1. Details of FIG. 1 have been described above. However, if the load instruction is dominated by another instruction, then a check for another load from the same object has occurred in every path leading to the current load. Thus, the compiler generates code as illustrated in FIG. 5.

Referring to FIG. 5, processing logic starts to execute the compiled code (processing block 540). During execution of the code, processing logic checks whether the load should be speculative for any reason other than the null reference check (processing block 541). If there is no other reason, then processing logic loads the data non-speculatively (processing block 545) and moves onto the next instruction (processing block 550). Otherwise, if there is at least one other reason, then processing logic speculatively loads the data (processing block 542) and checks whether the speculative load fails (processing block 543). If the speculative load fails, processing logic loads the data non-speculatively (processing block 544) and then moves onto the next instruction in the main instruction sequence (processing block 550). If the speculative load does not fail, processing logic moves onto the next instruction in the main instruction sequence (processing block 550).

Implementing the null reference check with the speculative load and speculation check instructions gives the compiler greater flexibility in scheduling instructions because the compiler can hoist the speculative load above any branch in a program. Consequently, the compiler can schedule the load earlier. Scheduling the load early is important for achieving good performance because the load tends to have high execution latency. In addition to being flexible, handling the null reference check and raising the exception within the compiled code is faster and less expensive than using the operating system to raise the exception. Furthermore, by combining the null reference check with the speculation check, the compiler can reduce the number of instructions on the main execution path because the null reference check is performed in the recovery code, which is not executed unless the speculative load fails. Reducing the number of instructions on the main execution path saves program execution time.

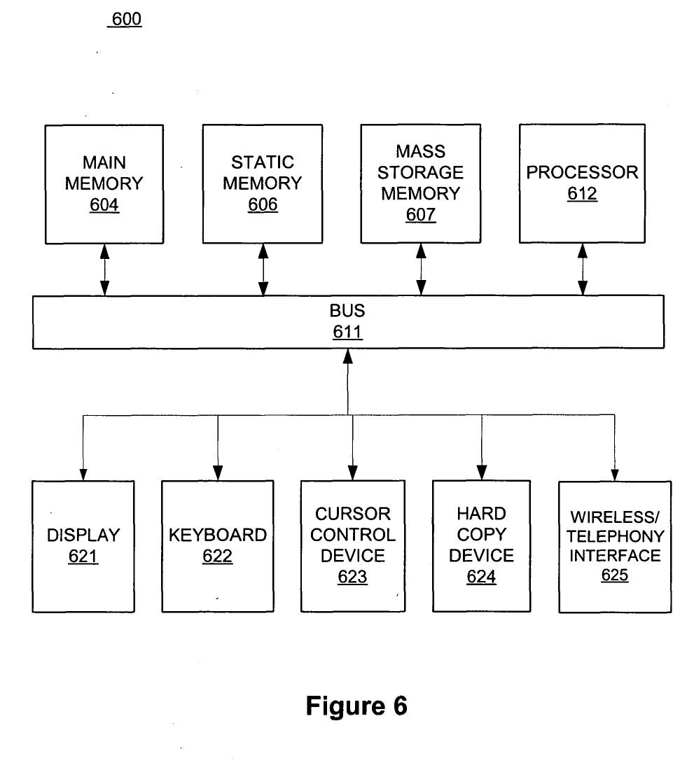

FIG. 6 is a block diagram of an exemplary computer system that may perform one or more of the operations described herein. Referring to FIG. 6, computer system 600 comprises a communication mechanism or bus 611 for communicating information, and a processor 612 coupled with bus 611 for processing information. Processor 612 includes a microprocessor, but is not limited to a microprocessor, such as, for example, Pentium®, Itanium®, PowerPC®, etc.

System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612.

Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Mass storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, track pad, stylus, or cursor direction keys, coupled to bus 611 for communicating direction information and command selections to processor 612, and for controlling cursor movement on display 621.

Another device that may be coupled to bus 611 is hard copy device 624, which may be used for printing instructions, data, or other information on a medium such as paper, film, or similar types of media. Furthermore, a sound recording and playback device, such as a speaker and/or microphone may optionally be coupled to bus 611 for audio interfacing with computer system 600. Another device that may be coupled to bus 611 is a wired/wireless communication capability 625 to communication to a phone or handheld palm device. Note that any or all of the components of system 600 and associated hardware may be used in various embodiments of the present invention. However, it can be appreciated that other configurations of the computer system may include some or all of the devices.

In one embodiment, main memory 604 stores a computer program, which includes a number of instructions. The instructions are executable by processor 612 to speculatively load data from a field of an object in response to a non-speculative load instruction in the computer program. After the speculatively loading the data, processor 612 checks whether the speculative load fails. If the speculative load fails, processor 612 raises a null reference exception. In one embodiment, the speculative load is a control speculative load instruction. In another embodiment, the speculative load is a data speculative load instruction.

In one embodiment, processor 612 executes a speculative load instruction in response to a non-speculative load instruction in the computer program. Then processor 612 checks whether the speculative load instruction fails. If the speculative load instruction fails, processor 612 checks whether the base address of the object from which the speculative load instruction accesses data is a null. If the base address is a null, processor 612 raises a null reference exception. Otherwise, processor 612 executes the load instruction non-speculatively. In one embodiment, the speculative load instruction is a control speculative load instruction. In another embodiment, the speculative load instruction is a data speculative load instruction.

The foregoing discussion merely describes some exemplary embodiments of the present invention. One skilled in the art will readily recognize from such discussion, the accompanying drawings and the claims that various modifications can be made without departing from the spirit and scope of the appended claims. The description is thus to be regarded as illustrative instead of limiting.

What is claimed is:

1. A method comprising:
executing a speculative load instruction to load data from an address;
checking whether the speculative load instruction execution fails; and
raising a null reference exception if the speculative load instruction fails.

2. The method of claim 1, wherein the speculative load instruction is a control speculative load instruction.

3. A method comprising:
executing a speculative load instruction to load data from an address, the address including a base address checking whether the speculative load instruction execution fails; and
checking whether the base address is null if the speculative load instruction fails.

4. The method of claim 3, further comprising raising a null reference exception if the speculative load instruction fails and the base address is null.

5. The method of claim 4, further comprising executing the non-speculative laod instruction if the speculative load instruction fails and the base address is not null.

6. The method of claim 3, further comprising deriving the speculative load instruction from a non-speculative load instruction.

7. The method of claim 3, wherein checking whether the base address is null includes comparing the address with an offset.

8. The method of claim 3, wherein the speculative load instruction is a control speculative load instruction.

9. A method for implementing a null reference check in a computer program comprising:
determining by a compiler whether an environment supports speculation;
generating a speculative load instruction in machine code for a load instruction in the computer program if the environment supports speculation; and
generating recovery code to raise a null reference exception when the speculative load instruction fails.

10. The method of claim 9, wherein the speculative load instruction is a control speculative load instruction.

11. A method for implementing a null reference check in a computer program comprising:
determining by a compiler whether an environment supports speculation;
generating a speculative load instruction in machine code for a load instruction in the computer program if the environment supports speculation, wherein the speculative load instruction loads data from an address including a base address; and
generating recovery code to check whether the base address is null and to raise a null reference exception if the base address is null.

12. The method of claim 11, wherein the speculative load instruction is a control speculative load instruction.

13. A machine-readable medium embodying instructions, the instructions, when executed by a processor, causing the processor to perform a method, the method comprising:
executing a speculative load instruction to load data from an address;
checking whether the speculative load instruction execution fails; and
raising a null reference exception if the speculative load instruction fails.

14. The machine-readable medium of claim 13, wherein the speculative load instruction is a control speculative load instruction.

15. A machine-readable medium embodying instructions, the instructions, when executed by a processor, causing the processor to perform a method, the method comprising:
executing a speculative load instruction to load data from an address, the address including a base address;
checking whether the speculative load instruction execution fails; and
checking whether the base address is null if the speculative load instruction fails.

16. The machine-readable medium of claim 15, wherein the method further comprises deriving the speculative load instruction from a non-speculative load instruction.

17. The machine-readable medium of claim 16, wherein the method further comprises:
raising a null reference exception if the base address is null; and
executing the non-speculative load instruction if the base address is not null.

18. The machine-readable medium of claim 15, wherein the speculative load instruction is a control speculative load instruction.

19. A machine-readable medium embodying instructions, the instructions, when executed by a processor, causing the processor to perform a method, the method comprising:
determining by a compiler whether an environment supports speculation;
generating a speculative load instruction in machine code for a load instruction in the computer program if the environment supports speculation; and
generating recovery code to raise a null reference exception when the speculative load instruction fails.

20. The machine-readable medium of claim 19, wherein the speculative load instruction is a control speculative load instruction.

21. A machine-readable medium embodying instructions, the instructions, when executed by a processor, causing the processor to perform a method, the method comprising:
determining by a compiler whether an environment supports speculation;
generating a speculative load instruction in machine code for a load instruction in the computer program if the environment supports speculation, wherein the speculative load instruction loads data from an address including a base address; and
generating recovery code to check whether the base address is null and to raise a null reference exception if the base address is null.

22. The machine-readable medium of claim 21, wherein the speculative load instruction is a control speculative load instruction.

23. A system comprising:
a dynamic random access memory (“DRAM”) device to store a computer program, the computer program including a plurality of instructions; and
a processor coupled to the DRAM device to execute the instructions causing the processor to perform a method, the method comprising
executing a speculative load instruction to load data from an address;
checking whether the speculative load instruction execution fails; and
raising a null reference exception if the speculative load instruction fails.

24. The system of claim 23, wherein the speculative load instruction is a control speculative load instruction.

25. A system comprising:
a dynamic random access memory (“DRAM”) device to store a computer program, the computer program including a plurality of instructions; and
a processor coupled to the DRAM device to execute the instructions causing the processor to perform a method, the method comprising
executing a speculative load instruction to load data from an address, the address including a base address;
checking whether the speculative load instruction execution fails; and
checking whether the base address is null if the speculative load instruction fails.

26. The system of claim 25, wherein the method further comprises deriving the speculative load instruction from a non-speculative load instruction.

27. The system of claim 26, wherein the method further comprises:
raising a null reference exception if the base address is null; and
executing the non-speculative load instruction if the base address is not null.

28. The system of claim 25, wherein the speculative load instruction is a control speculative load instruction.

29. A system comprising:
a dynamic random access memory (“DRAM”) device to store a computer program, the computer program including a plurality of instructions; and
a processor coupled to the DRAM device to execute the instructions causing the processor to perform a method, the method comprising
determining at compile time whether an environment supports speculation;
generating a speculative load instruction in machine code for a load instruction in the computer program if the environment supports speculation; and
generating recovery code to raise a null reference exception when the speculative load instruction fails.

30. The system of claim 29, wherein the speculative load instruction is a control speculative load instruction.

31. A system comprising:
a dynamic random access memory (“DRAM”) device to store a computer program, the computer program including a plurality of instructions; and
a processor coupled to the DRAM device to execute the instructions causing the processor to perform a method, the method comprising
determining at compile time whether an environment supports speculation;
generating a speculative load instruction in machine code for a load instruction in the computer program if the environment supports speculation, wherein the speculative load instruction loads data from an address including a base address; and
generating recovery code to check whether the base address is null and to raise a null reference exception if the base address is null.

32. The system of claim 31, wherein the speculative load instruction is a control speculative load instruction.

33. A method comprising:
generating a plurality of speculative load instructions for a plurality of load instructions in a computer program, each of the plurality of load instructions being dependent on one or more of the plurality of load instructions;
generating an instruction to check whether one or more of the plurality of speculative load instructions fail; and
generating recovery code to raise a null reference exception when one or more of the plurality of speculative load instructions fail.

34. The method of claim 33, wherein the plurality of speculative load instructions includes one or more control speculative load instructions.
